(19) United States
(12) Patent Application Publication
(10) Pub. No.: US 2009/0021087 A1
(43) Pub. Date: Jan. 22, 2009

(54) MOTOR

(75) Inventors: Jumpei KITAMURA, Kyoto (JP); Yuji YABUUCHI, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Minami-ku (JP)

(21) Appl. No.: 12/174,686

(22) Filed: Jul. 17, 2008

(30) Foreign Application Priority Data
Jul. 18, 2007 (JP) 2007-187657

(51) Int. Cl. H02K 5/16; H02K 15/14

(52) U.S. Cl. 310/43; 29/596

(57) ABSTRACT

A motor includes a rotor that is rotatable about a center axis, a stator facing the rotor, a bearing housing arranged to support the stator and having a plurality of fixing portions, and a base having a through hole. The base is fixed to the bearing housing via the fixing portions. The base also includes a recess and at least some of the fixing portions are engaged in the recess. At least one of the fixing portions is arranged to engage a surface at a radially inner portion of the base.

### BACKGROUND OF THE INVENTION

1. Field of the Invention

The present invention relates to a motor having a bearing housing.

2. Description of the Related Art

Various kinds of devices and electronic components are disposed inside an electronic device. Exemplary devices disposed inside an electronic device include motors and fans.

Electronic devices are used in various environments. For instance, an electronic component may be placed in an environment where the ambient temperature is below zero degrees Celsius (the freezing point). In such an environment, the interior temperature of the electronic device sometimes falls below the freezing point. Meanwhile, a large amount of heat is generated from the electronic components inside the electronic device. The heat sometimes raises the interior temperature of the electronic device to a temperature as high as around 100 degrees Celsius.

Accordingly, the devices and electronic components to be disposed inside electronic devices that are used in various environments are required to be durable enough to withstand changes in temperature from a low temperature to a high temperature. In a motor or a fan, for instance, a problematic crack may occur at a joined portion between a resin component and a metal component, as a result of yielding to a change in temperature as mentioned above.

### SUMMARY OF THE INVENTION

According to a preferred embodiment of the present invention, a motor includes a rotor that is rotatable about a central axis, a stator arranged to oppose the rotor, a bearing housing supporting the stator and having a plurality of fixing portions, and a base having a through hole, and the base and the bearing housing are integral with each other through the fixing portions. With this structure, the bearing housing and the base can resist against a change in stress that occurs internally due to an external impact or a change in temperature.

According to another preferred embodiment of the present invention, there is provided a method of manufacturing a bearing housing and a base in a motor that are formed integrally through a plurality of fixing portions, which motor includes a rotor that is rotatable about a central axis, a stator arranged to oppose the rotor, the bearing housing supporting the stator and having the plurality of fixing portions, and the base having a through hole. The method includes the steps of: a) forming the base through press working; b) setting at least a portion of the base inside a mold; c) pouring molten resin into the mold; d) cooling and solidifying the resin to integrate the resin with the base; and e) taking the resin and the base out of the mold to prepare the bearing housing integrated with the base. According to this method, it becomes possible to easily form a bearing housing and a base capable of resisting against a change in stress that occurs internally due to an external impact or a change in temperature.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a cross-sectional view showing a fan in which a motor according to a first preferred embodiment of the present invention is mounted.

FIG. 2 is a plan view showing a base and a bearing housing according to the first preferred embodiment of the present invention.

FIG. 3 is a bottom view showing the base and the bearing housing according to the first preferred embodiment of the present invention.

FIG. 4 is a plan view of the base and the bearing housing according to the first preferred embodiment of the present invention.

FIG. 5 is a cross-sectional view showing a modification of the fan according to the first preferred embodiment of the present invention.

FIG. 6 is a flowchart showing steps of a preferred method of forming the bearing housing and the base each other according to a preferred embodiment of the present invention.

FIGS. 7 to 10 are cross-sectional views of a mold used in the preferred method of forming the base and the bearing housing integrally with each other according to a preferred embodiment of the present invention.

### DETAILED DESCRIPTION OF PREFERRED EMBODIMENTS

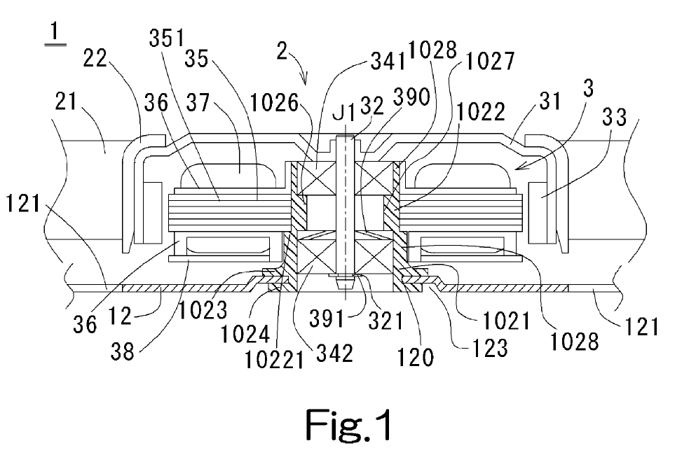

Referring to FIGS. 1 through 10, preferred embodiments of the present invention will be described in detail. It should be noted that in the explanation of preferred embodiments of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### First Preferred Embodiment

FIG. 1 is a cross-sectional view showing a fan 1 in which a motor according to a first preferred embodiment of the present invention is mounted. As shown in FIG. 1, the fan 1 includes an impeller 2, a stator 3, a base 12, and a bearing housing 1021.

As shown in FIG. 1, the impeller 2 is rotatable about a central axis J1 and includes a plurality of rotor blades 21 and a substantially cylindrical cup 22. The rotor blades 21 are arranged at equal or substantially equal pitch intervals around the central axis J1 on the outer peripheral surface of the cup 22 and preferably are formed integrally with the cup 22 through injection molding using resin. A covered and substantially cylindrical rotor holder 31 made of metal is fixed on the inner peripheral surface of the cup 22 preferably by press fitting or adhesive bonding, for example. A first end portion of a substantially columnar shaft 32 is press fitted and fixed at the center of the cover of the rotor holder 31. A substantially annular rotor magnet 33 is fixed on the inner peripheral surface of the rotor holder 31 preferably by press fitting or adhesive bonding, for example. The rotor magnet 33 has a plurality of magnetic poles arranged alternately along a circumferential direction. Also, the inner peripheral surface of the rotor magnet 33 radially opposes the stator 3.

An annular groove 321 is formed along the outer peripheral surface at the axially lower side of the shaft 32. A wire ring 391, which has a substantially annular shape, is fixed along the annular groove 321.

The stator 3 is supported on the outer peripheral surface of the substantially cylindrical bearing housing 1021. The stator 3 includes an armature 35 and a circuit board 38.

The armature 35 includes a stator core 351, a plurality (for example, two in the present preferred embodiment) of insulators 36, and coils 37. The stator core 351 is preferably formed from a plurality of laminated thin silicon steel plates and has an annular core back (not shown) centered at the central axis J1 and a plurality of (e.g., four) pole teeth that are integrally formed with the core back. The pole teeth project radially outward from the core back and are arranged circumferentially at equal pitch intervals on the outer periphery of the core back.

The insulators 36 are preferably formed from an insulating material such as resin. The two insulators 36 are attached to the stator core 351 from the axially upper and lower sides respectively and cover each of the pole teeth.

The coils 37 are wound on each of the pole teeth of the stator core 351 with the insulators 36 interposed therebetween. As described above, the insulators 36 are made of an insulating material; therefore, the insulators 36 can electrically isolate the stator core 351 from the coils 37.

The circuit board 38 is disposed axially under the armature 35 and is supported on an insulator 36. A plurality of electronic components (not shown) are mounted on the circuit board 38, and a control circuit is configured on the circuit board 38 to control currents applied from an external power source (not shown) to and through the armature 35. Exemplary electronic components that are mounted on the circuit board 38 include a Hall element and a drive IC. First ends of the coils 37 are electrically connected to the circuit board 38. When a current is applied from the external power source by way of the circuit board 38 to the stator core 351, a magnetic field is produced in the stator core 351. The interaction between the magnetic field produced in the stator core 351 and the magnetic field of the rotor magnet 33 generates rotary torque around the central axis J1 between the stator core 351 and the rotor magnet 33. This rotary torque drives and rotates the impeller 2. As a result, an air flow is generated from the upper side to the lower side in the direction of the central axis J1.

As shown in FIG. 1, the bearing housing 1021 preferably has a substantially cylindrical shape and is preferably formed through injection molding using resin. A first stepped portion 10221 is provided on the outer peripheral surface of a cylindrical portion 1022 of the bearing housing 1021. The first stepped portion 10221 supports and axially locates the stator 3.

A small diameter portion 1027 and two large diameter portions 1028 that are larger in diameter than the small diameter portion 1027 are provided on the inner peripheral surface of the cylindrical portion 1022 of the bearing housing 1021. Two second stepped portions 1026 are provided along the boundaries between the small diameter portion 1027 and each of the large diameter portions 1028. The inner peripheral surfaces of the small diameter portion 1027 and large diameter portions 1028 and the second stepped portions 1026 support ball bearings 341 and 342. Also, the second stepped portions 1026 axially locate the ball bearings 341 and 342 relative to the bearing housing 1021. A coil spring 390 is disposed on the axially upper side of the ball bearing 342. The coil spring 390 serves to apply a preload on each of the ball bearings 341 and 342. The ball bearings 341 and 342 rotatably support the shaft 32. As described above, the wire ring 391 is also fixed to the shaft 32. Even if the shaft 32 is moved axially upward by an external impact and the like, the wire ring 391 axially collides with the ball bearing 342, which prevents the shaft 32 from escaping axially from the ball bearing 342.

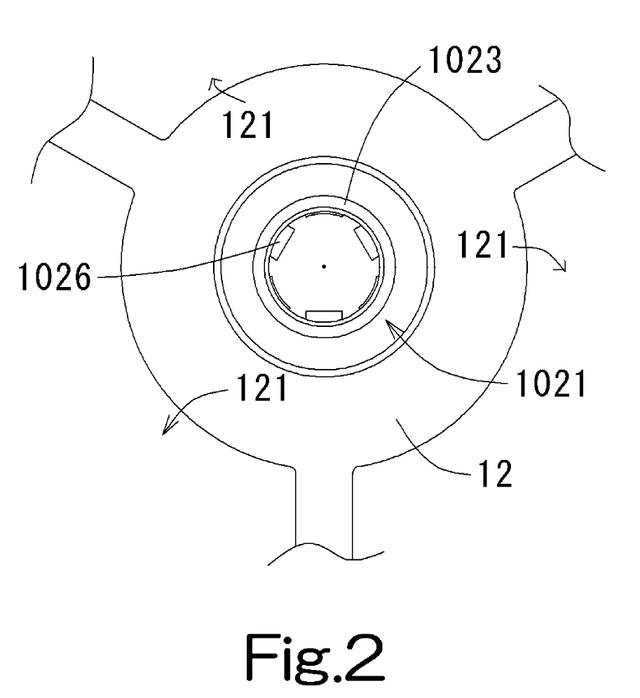

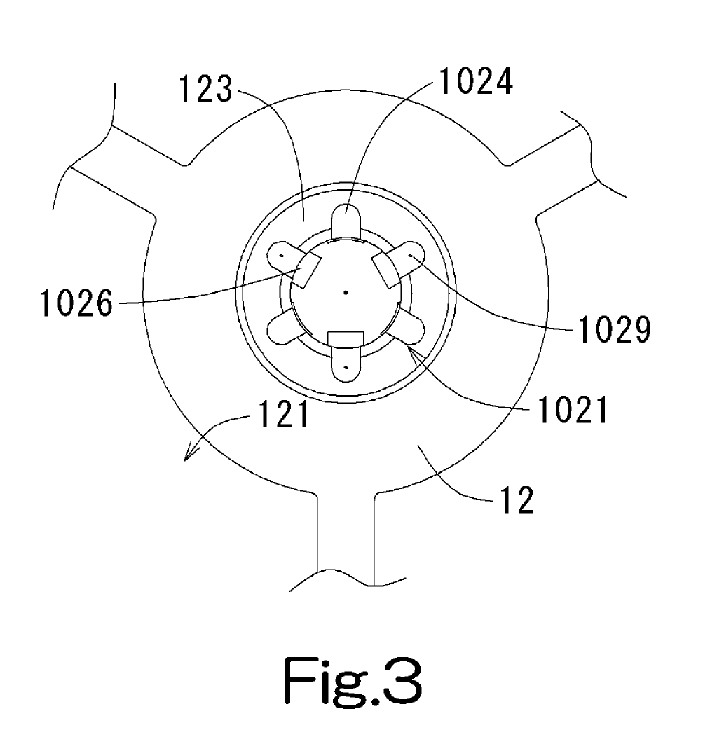

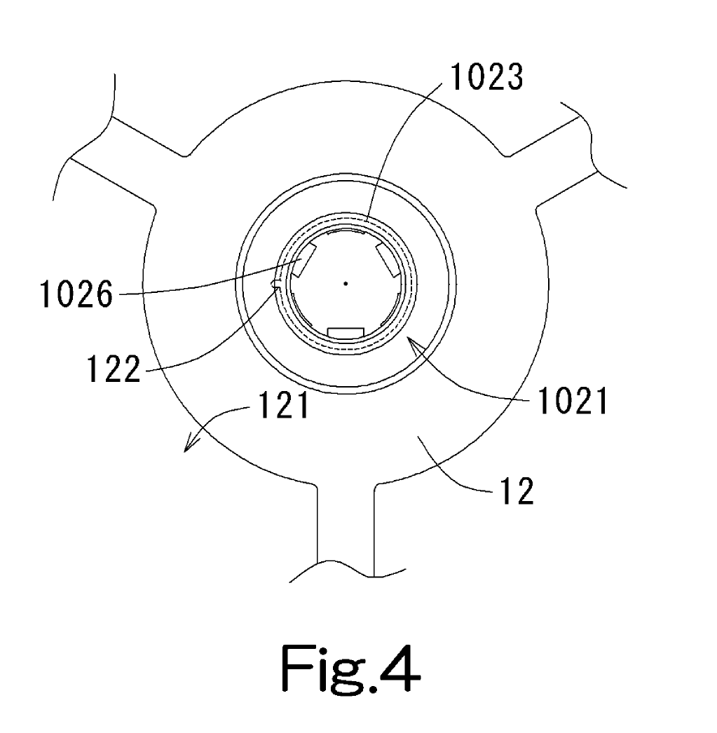

FIG. 2 is a plan view of the base 12 and the bearing housing 1021 according to the first preferred embodiment of the present invention. FIG. 3 is a bottom view of the base 12 and the bearing housing 1021 according to the first preferred embodiment of the present invention. FIG. 4 is a plan view of the base 12 and the bearing housing 1021 according to the first preferred embodiment of the present invention. In FIG. 4, a transparent view of the bearing housing 1021 is shown.

As shown in FIGS. 1 to 4, an annular fixing portion 1023 and a plurality of (preferably six in the present preferred embodiment, for example) fixing portions 1024 are provided at the axially lower end of the bearing housing 1021. The annular fixing portion 1023 has a ring shape and is formed integrally with the outer peripheral surface of the cylindrical portion 1022 of the bearing housing 1021. The fixing portions 1024 are disposed at positions that are axially below the annular fixing portion 1023, on the cylindrical portion 1022 of the bearing housing 1021. The fixing portions 1024 are arranged around the central axis J1 preferably at equal or substantially equal pitch intervals along the bearing housing 1021, with circumferential gaps in between each fixing portion 1024.

As shown in FIGS. 1 to 4, the base 12 is a plate-like member with a through hole 120, a plurality of (preferably three in the present preferred embodiment, for example) intake ports 121, and a recess 123. The through hole 120 is provided at the center of the base 12 and is integrated in a portion of the bearing housing 1021. The intake ports 121, each preferably having a fan-like shape, are arranged circumferentially around the central axis J1 at equal pitch intervals. The shape of the intake ports 121 need not be particularly limited.

As shown in FIGS. 1 and 3, the recess 123 has a substantially annular shape centered at the through hole 120 and is protruded axially upward. The axial size (i.e., the depth) of the recess 123 is larger than the axial size (i.e., the thickness) of the above-mentioned fixing portions 1024. As shown in FIG. 1, the fixing portions 1024 are contained in the recess 123. With this structure, the fixing portions 1024 form an equal plane to the plane of the base 12 excluding the recess 123 which plane is substantially perpendicular to the central axis J1. As a result, fixing of the fan 1 to an electronic device and the like is facilitated via the base 12.

The base 12 is preferably formed from a metal plate through press working (e.g., punching or drawing) and preferably is subjected to injection molding (e.g., insert molding or outsert molding) using resin to be integrated with the bearing housing 1021.

The insert molding is a method including setting a component (e.g., made of metal) so that the whole thereof is held inside a mold, subsequently injecting resin through a gate into the mold, followed by cooling and solidifying the resin. This method allows resin to be molded into any shape as well as to be molded integrally with the component. The outsert molding is a method in which only a portion of a component is disposed inside a mold, and resin is injected into the mold through a gate and is cooled and solidified, so that the resin is molded into a predetermined shape while being formed integrally with the component.

Through such injection molding using resin, there is provided a bearing housing 1021 with its cylindrical portion 1022, annular fixing portion 1023, and fixing portions 1024 integrally formed with the base 12, as shown in FIGS. 1 to 4.

The annular fixing portion 1023 meets the upper surface at the radially inner side of the base 12 (i.e., the upper surface of a substantially annular portion configuring the recess 123). On the other hand, the circumferentially arranged fixing portions 1024 meet the lower surface at the radially inner side of the base 12 (i.e., the lower surface of the substantially annular portion configuring the recess 123) and have a plurality of (preferably three in the present preferred embodiment) later-described gate cutting marks 1029 formed thereon. In other words, the base 12 is fixed integrally with the bearing housing 1021 such that the base 12 is held between the annular fixing portion 1023 and the fixing portions 1024.

Generally, resin materials expand more easily than metal materials upon application of heat. Therefore, when heat is applied to the base 12 and the bearing housing 1021, the bearing housing 1021 made of resin develops larger internal stress, hence expanding more easily, in comparison with the base 12 made of a metal material. As shown in FIG. 3, however, the circumferentially spaced arrangement of the fixing portions 1024 of the bearing housing 1021 permits the fixing portions 1024 to expand in the circumferential direction when applied with heat. In other words, the stress that occurs within each fixing portion 1024 can be released in the circumferential direction.

In contrast, resin materials shrink more easily than metal materials when cooled. Thus, when the base 12 and the bearing housing 1021 are cooled, the bearing housing 1021 made of resin develops larger internal stress, hence shrinking more easily. However, since the fixing portions 1024 have the above-described structure, each fixing portion 1024 can shrink easily in the circumferential direction. In other words, the stress that occurs within each of the fixing portions 1024 can be released in the circumferential direction.

Accordingly, because of the joint portion between the bearing housing 1021 and the base 12 taking the structure as described above, the stress that occurs within the bearing housing 1021 and the base 12 is distributed to the plurality of fixing portions 1024 when there is a change in ambient temperature in the vicinity of the fan 1. Consequently, a temperature change-induced crack can be prevented at the joint portion between the bearing housing 1021 and the base 12.

It should be noted that in the present preferred embodiment, the fixing portions 1024 are disposed axially below the annular fixing portion 1023. The axial positions of the fixing portions 1024 and of the annular fixing portion 1023, however, may be reversed. Also, the annular fixing portion 1023 may be changed to additional fixing portions 1024.

Further, as shown in FIG. 4, a locking portion 122 is provided on the recess 123. In the present preferred embodiment, the locking portion 122 is preferably formed as a notch. In forming the bearing housing 1021 integrally with the base 12 through injection molding using resin, the locking portion 122 allows the resin to flow therein. With this structure, the joint strength between the base 12 and the bearing housing 1021 can be increased. The locking portion 122 need not necessarily be a notch. The locking portion 122 may be a groove or a through hole instead of a notch, and its form is not particularly limited.

The shapes of the annular fixing portion 1023 and of the fixing portions 1024 are not limited to the shapes shown in FIGS. 1 to 4. For example, the annular fixing portion 1023 and the fixing portions 1024 may not be flat (e.g., may be provided with a recess, projection, through hole, groove, or the like). In addition, the annular fixing portion 1023 and the fixing portions 1024 may be formed into a rectangle, polygon, semicircle, or the like, in a planar view. Moreover, adjacent fixing portions 1024 may take different shapes from each other. The fixing portions 1024 need not necessarily be arranged around the central axis J1 at equal pitch intervals, but the fixing portions 1024 are preferably arranged symmetrically with respect to the central axis J1. By doing so, when, e.g., stress occurs due to an external impact or a change in ambient temperature, the stress can be distributed uniformly to each of the fixing portions 1024. As a result, the fixing portions 1024 become less prone to cracks.

Furthermore, the shape of the base 12 is not limited to the shape shown in FIGS. 1 to 4. The inner peripheral surface encircling the through hole 120, the recess 123, and other surfaces of the base 12 may be provided with a recess or a projection, and these surfaces need not necessarily be flat. The portion where the base 12 is engaged with the bearing housing 1021 (i.e., the recess 123) may be arranged in parallel to the central axis J1 or may be slanted relative to the central axis J1.

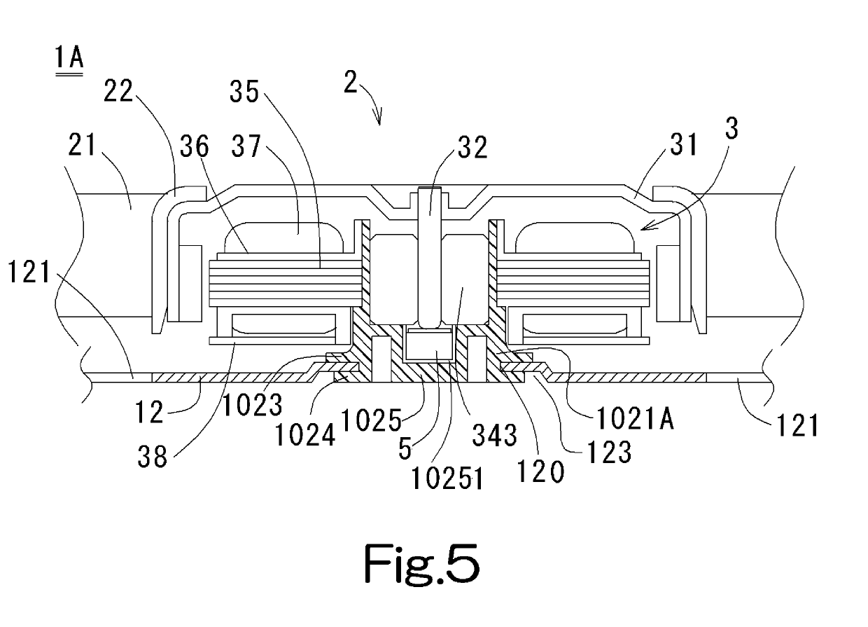

The shape of the bearing housing 1021 is not limited to the shape shown in FIGS. 1 to 4. FIG. 5 is a cross-sectional view of a fan 1A, showing a modification of the fan 1 according to the first preferred embodiment of the present invention. In the following description, like reference numerals identify the same structures as those of the fan 1 shown in FIGS. 1 to 4, and description thereof is not given.

A bearing housing 1021A in the fan 1A is a covered, substantially cylindrical member with a bottom portion 1025. The bottom portion 1025 and the base 12 are formed integrally with each other through injection molding using resin. A substantially cylindrical sleeve 343 is disposed inside the bearing housing 1021A. The sleeve 343 is preferably made of a sintered metal prepared by sintering a powder metal and is impregnated with lubricant oil. The sleeve 343 rotatably supports the shaft 32 with lubricant oil filled therebetween. The shaft 32 in FIG. 5 is preferably made of a magnetic material such as stainless steel. A recess 10251 is provided in the bottom portion 1025 so as to oppose the axially lower end surface of the shaft 32. The recess 10251 contains an attraction magnet 5 that attracts the shaft 32 of a magnetic material in an axially downward direction.

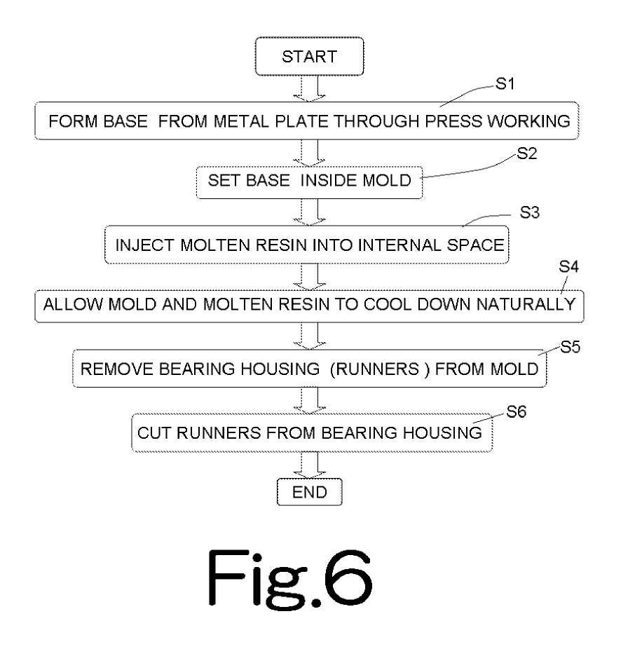

A description is given below of a method of forming the bearing housing and the base integrally with each other. FIG. 6 is a flowchart showing steps of the method of forming the bearing housing and the base integrally with each other according to a preferred embodiment of the present invention. The following description is made using the bearing housing 1021 and the base 12 of the foregoing first preferred embodiment of the present invention. The method described below may, however, be applied to a bearing housing and a base having different shapes or made of different materials.

As an initial step, a metal plate is subjected to press working such as punching, bending, and drawing to form the base 12 (step S1). In forming the base 12 through press working, the through hole 120, the intake ports 121, and the recess 123 are also formed in the base 12 preferably via punching and drawing, for example. Molten resin is to be injected onto the surface at the radially inner side of the base 12 (portion to be joined with the bearing housing 1021). Therefore, the surface at the radially inner side of the base 12 is required to have such a thickness that averts deformation that may be caused by the pressure applied during injection of resin. The necessary thickness may be, e.g., approximately 1.0 mm.

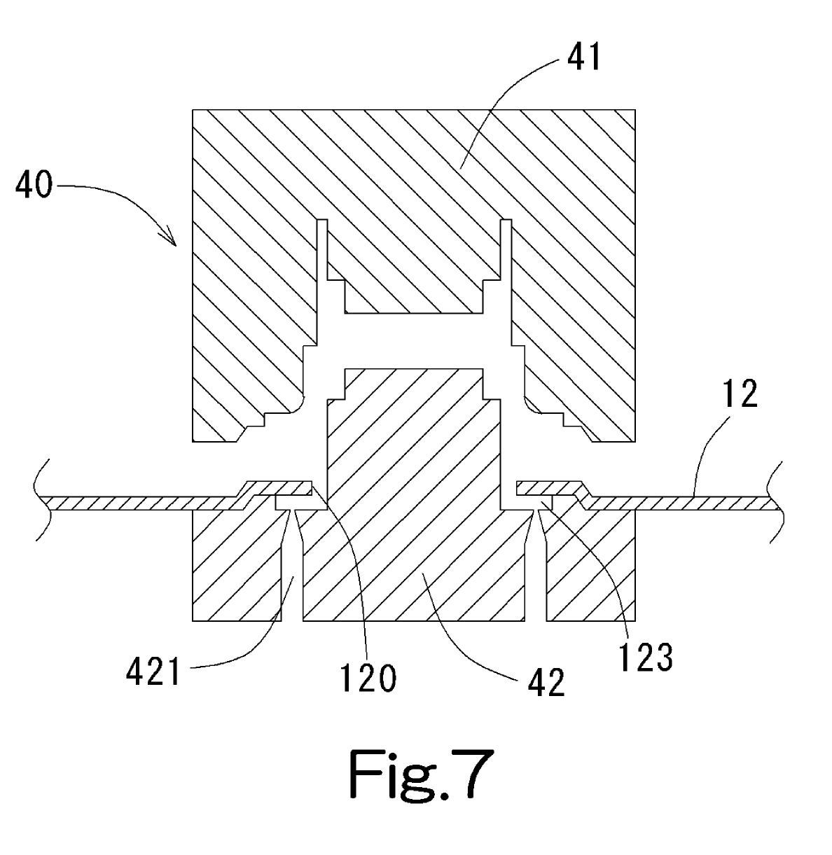

Next, the base 12 is set inside a mold 40 for injection molding (step S2). FIG. 7 is a cross-sectional view of a mold applied to a preferred method of forming the base 12 and the bearing housing 1021 integrally with each other according to the present invention. As shown in FIG. 7, the mold 40 is constructed with a combination of one or more movable molds 41 and one or more stationary molds 42 and is mounted to an injection molding machine (not shown). The injection molding machine includes a mechanism for moving the movable mold 41 and a mechanism for injecting resin into the mold 40. The stationary mold 41 is provided with a plurality of gates 421, which are openings to introduce molten resin into the mold 40. The positions of the gates 421 in the mold correspond to the positions of the fixing portions 1024 of the bearing housing 1021.

As shown in FIG. 7, the base 12 that has been formed in step S1 is disposed inside the mold 40. At this point, a portion in the recess 123 of the base 12 axially meets the stationary mold 42. That is, the recess 123 serves to axially locate the base 12 on the stationary mold 42. In addition, the central axis of the through hole 120 provided at the center of the base 12 is coincident with the central axis of the bearing housing 1021 in the mold 40.

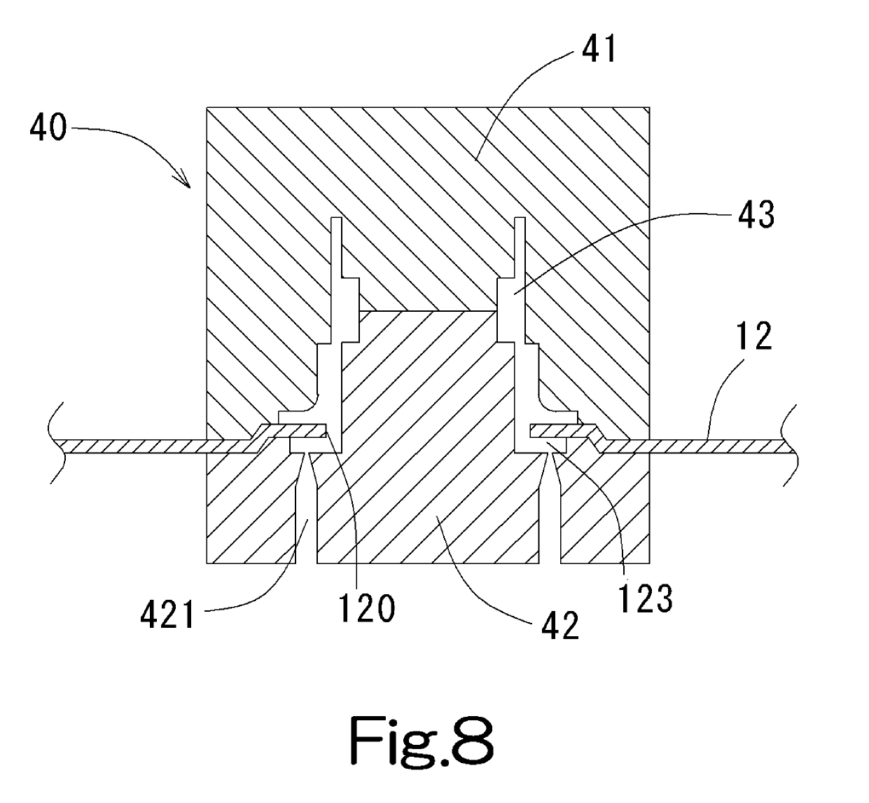

FIG. 8 is a cross-sectional view of the mold used in a preferred method of forming the base 12 and the bearing housing 1021 integrally with each other according to the present invention. As shown in FIG. 8, after the base 12 is set on the stationary mold 42, the movable mold 41 moves axially downward to axially meet the stationary mold 42 and the base 12. An internal space 43 is formed inside the mold 40 when the movable mold 41 is combined with the stationary mold 42.

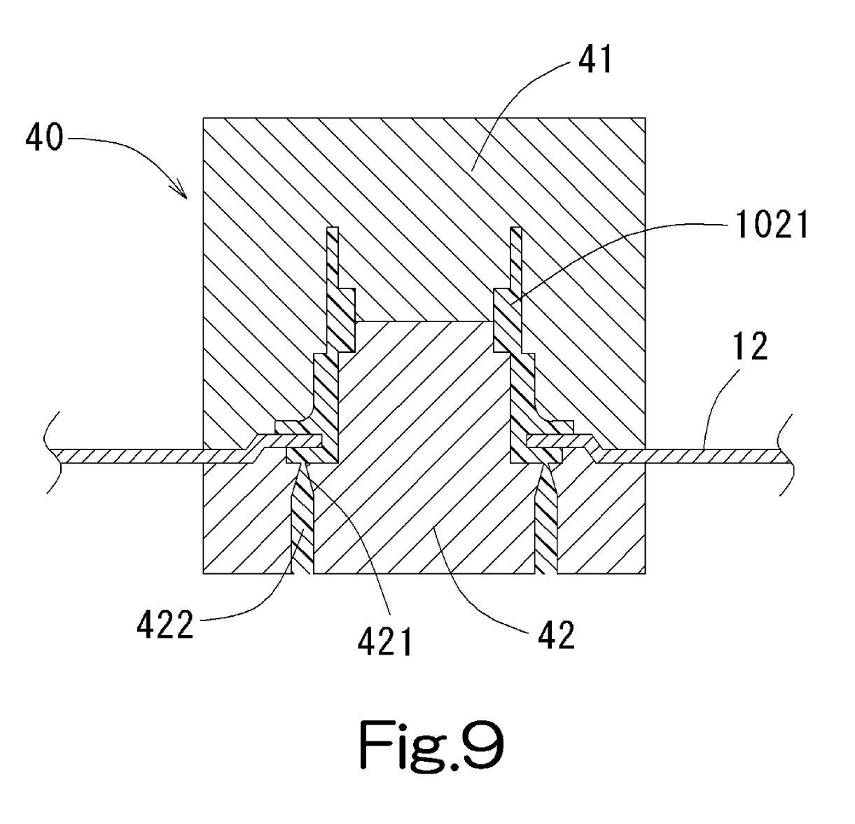

Then, molten resin is injected into the internal space 43 (step S3). FIG. 9 is a cross-sectional view of the mold associated with the preferred method of forming the base 12 and the bearing housing 1021 according to the present invention. As shown in FIG. 9, following step S3, the molten resin to form the bearing housing 1021 is poured under pressure into the internal space 43 in the mold 40 through the gates 421 so that the molten resin spreads into every corner of the internal space 43. The molten resin also fills around the base 12 disposed inside the internal space 43, the locking portion 122 of the base, and the gates 421.

Subsequently, the mold 40 is cooled together with the molten resin naturally or forcedly (step S4). Inside the mold 40, the cooled and solidified resin forms the shape of the bearing housing 1021 fixed integrally with the base 12. That is, the cylindrical portion 1022, the annular fixing portion 1023, and the fixing portions 1024 of the bearing housing 1021 are all formed while the base 12 is integrated with the bearing housing 1021 by being held between the annular fixing portion 1023 and the fixing portions 1024. Also, the poured resin is cooled and solidified in the gates 421 in the stationary mold 42. The resin solidified in the gates 421 is referred to as runners 422. In the gates 421, the runners 422 are linked to the fixing portions 1024 of the bearing housing 1021 at the border between the internal space 43 of the mold 40 and the gates 421.

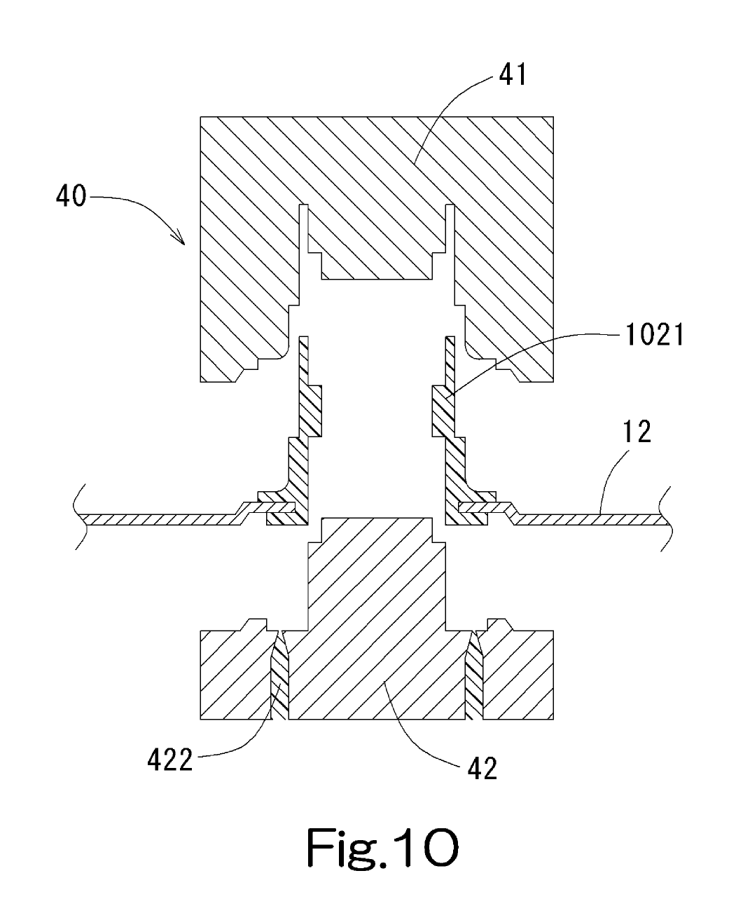

Then, the bearing housing 1021 with which the base 12 and the runners 422 are integrated is taken out from the mold 40 (step S5). FIG. 10 is a cross-sectional view of the mold associated with a preferred method of forming the base 12 and the bearing housing 1021 according to the present invention. As shown in FIG. 10, the movable mold 41 is separated from the stationary mold 42 axially upward relative to the stationary mold 42. Simultaneously therewith, the bearing housing 1021 with which the base 12 and the runners 422 are integrated is taken out from the mold 40 using an ejector pin and the like.

Then, the runners 422 are cut from the bearing housing 1021 (step S6). At this point, the gate cutting marks 1029, which are marks left upon separation of the runners 422, are formed at the portions where the runners 422 have been linked, in the fixing portions 1024 of the bearing housing 1021.

The runners 422 are disposed of after the molding. Thus, the smaller the weight of the runners 422, the less the necessary quantity of resin to form the bearing housing 1021 is. In the present preferred embodiment, the positions of the gates 421 in the mold 40 correspond to the positions where the fixing portions 1024 are formed. In addition, the runners 422 are formed within the gates 421 leading to the outside of the mold 40. Therefore, the gates 421 are preferably arranged at positions so as to provide the shortest channels between the internal space 43 of the mold 40 and the exterior of the mold 40, thereby reducing the weight of the runners 422.

By conducting the foregoing steps S1 to S6, there can be obtained a bearing housing 1021 with which the base 12 is fixed integrally. Then, various components as previously described, such as the stator 3, the rotor holder 31, the rotor magnet 33, and the shaft 32, are attached thereto, whereby a motor is constructed. Further, the impeller 2 is mounted to the rotor holder 31 of the motor, so that a fan 1 is provided. It should be noted that methods of forming the bearing housing and the base of the fan 1A shown in FIG. 5 and of assembling the fan 1A are approximately the same as the methods used for the fan 1.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising:
a rotor rotatable about a center axis;
a stator facing the rotor;
a bearing housing arranged to support the stator and having a plurality of fixing portions; and
a base having a through hole; wherein
the base is fixed to the bearing housing via the fixing portions.

2. The motor according to claim 1, wherein the base includes a recess and at least some of the fixing portions are engaged in the recess.

3. The motor according to claim 1, wherein at least one of the fixing portions is arranged to engage a surface at a radially inner portion of the base.

4. The motor according to claim 1, wherein the plurality of fixing portions of the bearing housing includes a first fixing portion and a plurality of second fixing portions, and at least a portion of the base is fixed between the first fixing portion and the plurality of second fixing portions.

5. The motor according to claim 1, wherein the first fixing portion has a ring shape.

6. The motor according to claim 1, wherein the second fixing portions are arranged so as to be spaced from each via gaps in a circumferential direction.

7. The motor according to claim 1, wherein the bearing housing is made of resin.

8. The motor according to claim 1, wherein the bearing housing is made of injection molded material.

9. The motor according to claim 4, wherein the base has a recess arranged to accommodate the second fixing portions.

10. The motor according to claim 1, wherein the base is made of metal.

11. The motor according to claim 1, wherein the base is made of pressed material.

12. The motor according to claim 1, wherein the base has at least one intake port.

13. The motor according to claim 1, wherein the base has at least one locking portion arranged to lock the base in the bearing housing at least partially.

14. A fan comprising the motor according to claim 1 and an impeller arranged to be driven by the motor and rotate about the center axis.

15. A method for manufacturing a motor comprising the steps of:
forming a base by pressing a material;
setting the base inside a mold;
injecting molten resin into an internal space of the mold;
cooling the mold and molten resin to form a bearing housing including a plurality of runners;
removing the bearing housing and the runners from the mold; and
cutting the runners from the bearing housing.

16. The method according to claim 15, wherein the molten resin is injected into the internal space of the mold via a plurality of gates in the mold.

17. The method according to claim 15, wherein the step of forming the base includes forming a plurality of fixing portions in the base such that each position of the fixing portions substantially corresponds to a position of a respective one of the gates in the mold.

18. The method according to claim 17, wherein at least some of the plurality of the fixing portions have a gate cutting mark.

19. The method according to claim 17, wherein the plurality of fixing portions includes a first fixing portion and a plurality of second fixing portions, and at least a portion of the base is fixed between the first fixing portion and the plurality of second fixing portions.

20. A method of manufacturing a fan comprising the steps of: manufacturing a motor according to the method of claim 15; and arranging an impeller so as to be driven by the motor.
